(19) United States
(12) Patent Application Publication
(10) Pub. No.: US 2011/0244943 A1
(43) Pub. Date: Oct. 6, 2011

(54) GAMING MACHINE AND A METHOD OF GAMING

(75) Inventors: Scott Milford, Las Vegas, NV (US); Scott Monroe Stewart, Las Vegas, NV (US)

(73) Assignee: ARISTOCRAT TECHNOLOGIES AUSTRALIA PTY LIMITED, North Ryde (AU)

(21) Appl. No.: 13/074,694

(22) Filed: Mar. 29, 2011

Related U.S. Application Data
(60) Provisional application No. 61/321,369, filed on Apr. 6, 2010.

(51) Int. Cl. A63F 9/24; A63F 13/00

(52) U.S. Cl. 463/20; 463/30

(57) ABSTRACT

A method of gaming includes rotating a plurality of mechanical reels mounted to a cabinet to a stopping position, each mechanical reel carrying a plurality of symbols at a plurality of symbol display positions arranged around the outer periphery of the mechanical reel, such that a selected subset of the symbol display positions of each mechanical reel are viewable by a player when the reels are stopped; controlling at least one video display adjacent to the mechanical reels to display at least one additional symbol of the symbols of at least one reel as a video symbol at a video symbol display position adjacent one of the viewable symbol display positions of the respective mechanical reel; and evaluating the symbols of the subsets and the at least one video symbol to determine whether to make an award.

### CROSS-REFERENCE TO RELATED APPLICATIONS

The present application claims the benefit of priority to U.S. Provisional Patent Application No. 61/321,369, filed on Apr. 6, 2010, entitled “A GAMING MACHINE AND A METHOD OF GAMING”, which is herein incorporated by reference in its entirety.

### FIELD

The invention relates to a gaming machine and a method of gaming.

### BACKGROUND

Mechanical reel based or “stepper” gaming machines are known where a plurality of mechanical reels are spun to a stop such that a plurality of symbols of the reels are visible to the player and the visible symbols are evaluated to determine whether to make an award to the player. Such machines are popular with many players, predominantly because such players like the physical nature of the gaming machine. A disadvantage of such machines is they are limited in terms of the variations on game play they can provide.

### SUMMARY

In a first aspect, the invention provides a gaming machine including:

a cabinet;

a game controller;

a plurality of mechanical reels mounted beside one another for rotatable movement relative to the cabinet, each mechanical reel carrying a plurality of symbols at a plurality of symbol display positions arranged around the outer periphery of the mechanical reel, the plurality of mechanical reels arranged relative to the cabinet such that a selected subset of the symbol display positions of each mechanical reel are viewable by a player when the reels are stopped, the symbols of the subsets being for use in the evaluation of an outcome of the game; and

at least one video display disposed adjacent the mechanical reels,

the game controller arranged to control the at least one video display to add to the symbols for use in the evaluation of the outcome of the game by displaying at least one additional symbol of the symbols of at least one reel as a video symbol at a video symbol display position adjacent one of the viewable symbol display positions of the respective mechanical reel.

In an embodiment, the symbols of the subsets are arranged in a plurality of rows and the game controller is arranged to add at least one video symbol for each reel to thereby add an additional row of symbols for use in the evaluation of the outcome of the game.

In an embodiment, the gaming machine is arranged to add a plurality of additional rows of symbols.

In an embodiment, the at least one video display is above the mechanical reels.

In an embodiment, the at least one video display is below the mechanical reels.

In an embodiment, the game controller is arranged to add each symbol such that an order of the symbols of each mechanical reel is preserved by each added video symbol.

In an embodiment, the game controller is arranged to add each video symbol in response to a video symbol condition being met.

In an embodiment, the video symbol condition is placement of a designated wager.

In an embodiment, the video symbol condition is occurrence of a designated game event.

In an embodiment, the game controller is arranged to determine whether to make an award to the player based on the symbols of the sets, each video symbol and a wager placed by a player of the gaming machine.

In an embodiment, the game controller is arranged to determine stopping positions of each of the mechanical reels.

In a second aspect, the invention provides a method of gaming including: rotating a plurality of mechanical reels mounted to a cabinet to a stopping position, each mechanical reel carrying a plurality of symbols at a plurality of symbol display positions arranged around the outer periphery of the mechanical reel, such that a selected subset of the symbol display positions of each mechanical reel are viewable by a player when the reels are stopped;

controlling at least one video display adjacent to the mechanical reels to display at least one additional symbol of the symbols of at least one reel as a video symbol at a video symbol display position adjacent one of the viewable symbol display positions of the respective mechanical reel; and

evaluating the symbols of the subsets and the at least one video symbol to determine whether to make an award.

In an embodiment, the symbols of the subsets are arranged in a plurality of rows and the method comprises adding at least one video symbol for each reel to thereby add an additional row of symbols for use in the evaluation of the outcome of the game.

In an embodiment, the method comprises adding a plurality of additional rows of symbols.

In an embodiment, the method comprises adding each symbol such that an order of the symbols of each mechanical reel is preserved by each added video symbol.

In an embodiment, the method comprises adding each video symbol in response to a video symbol condition being met.

In an embodiment, the video symbol condition is placement of a designated wager.

In an embodiment, the video symbol condition is occurrence of a designated game event.

In an embodiment, the method comprises determining whether to make an award to the player based on the symbols of the sets, each video symbol and a wager placed by a player of the gaming machine.

In a third aspect, the invention provides computer program code which when executed implements the above method.

In a fourth aspect, the invention provides a tangible computer readable medium including the above program code.

### BRIEF DESCRIPTION OF DRAWINGS

Certain example embodiments of the invention will now be described with reference to the accompanying drawings in which:

FIG. 1 is a perspective view of a stand alone gaming machine;

FIG. 2 is a block diagram of the functional components of a gaming machine;

FIG. 3 is a schematic diagram of the functional components of a memory;

FIG. 4 is a schematic diagram of a network gaming system;

FIG. 5 shows the reels and video display of the gaming machine of FIG. 1 in more detail;

FIG. 6 shows an example of the video display being used to display an additional row of symbol display positions;

FIG. 7 is a functional block diagram of a gaming machine; and

FIG. 8 is a flow chart of an embodiment.

Features, further aspects, and advantages of the present invention will become apparent from the following description of embodiments thereof, by way of example only, with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in at least one embodiment, at least one of the elements is hereby expressly defined to include a tangible medium such as a memory, DVD, CD, Blu-ray, etc., storing the software and/or firmware.

Referring to the drawings, there is shown a gaming machine having a plurality of mechanical reels, a video display and a game controller arranged to control the video display to add to the symbols of the mechanical reels which are displayed for use in evaluation of the game outcome. In an embodiment, the video display extends the number of symbols display by each mechanical reel to provide an extra row of symbols. In an embodiment the video display displays additional symbols when a video symbol condition is met.

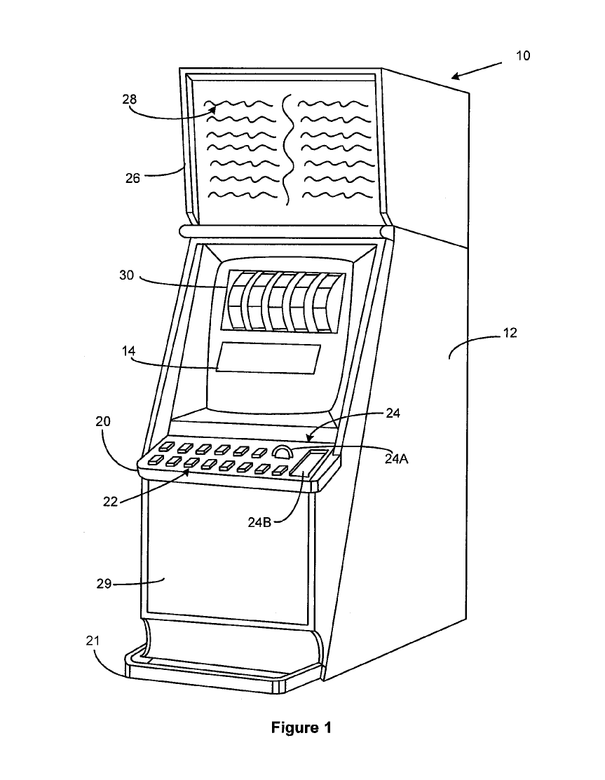

A stand alone gaming machine 10 is illustrated in FIG. 1. The gaming machine 10 includes a console 12 having five mechanical reels 30, each carrying a plurality of symbols at respective ones of a plurality of symbol display positions and a video display 14 on which are displayed representations of symbols at video symbol display positions. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

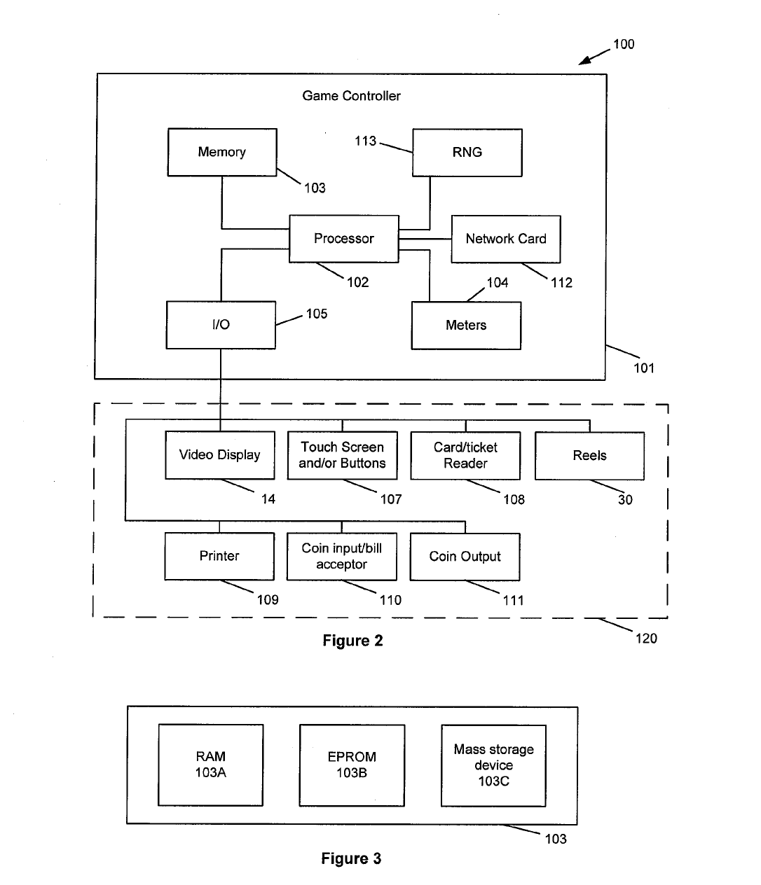

The display 14 shown in FIG. 2 is in the form of a video display unit, particularly a cathode ray tube screen device. Alternatively, the display 14 may be a liquid crystal display, plasma screen, any other suitable video display unit. The top box 26 may also include a display, for example a video display unit, which may be of the same type as the display 14, or of a different type.

FIG. 2 shows a block diagram of the gaming machine of FIG. 1.

The gaming machine 10 includes a game controller 101 having a processor 102 mounted on a circuit board. Instructions and data to control operation of the processor 102 are stored in a memory 103, which is in data communication with the processor 102. Processor 102 processes game play instructions made by the player in accordance with game play rules and outputs game play outcomes. Typically, the game play rules are stored as program code in a memory 103 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

Typically, the gaming machine 10 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 10. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 2, a player interface 120 includes peripheral devices that communicate with the game controller 101 including video display 14, a touch screen and/or buttons 107 (which provide a game play mechanism), a card and/or ticket reader 108, a printer 109, a bill acceptor and/or coin input mechanism 110, a coin output mechanism 111 and mechanical reels 30. Typically, the mechanical reels are driven by stepper motors (not shown) to enable accurate control of the stopping position of each reel.

Additional hardware may be included as part of the gaming machine 10, or hardware may be omitted based on the specific implementation. For example, while buttons or touch screens are typically used in gaming machines to allow a player to place a wager and initiate a play of a game, any input device that enables the player to input game play instructions may be used. For example, in some gaming machines a mechanical handle is used to initiate a play of the game.

In addition, the gaming machine 10 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

FIG. 3 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 10 to be distributed, for example input/output devices 14,107,108,109,110,111 to be provided remotely from the game controller 101.

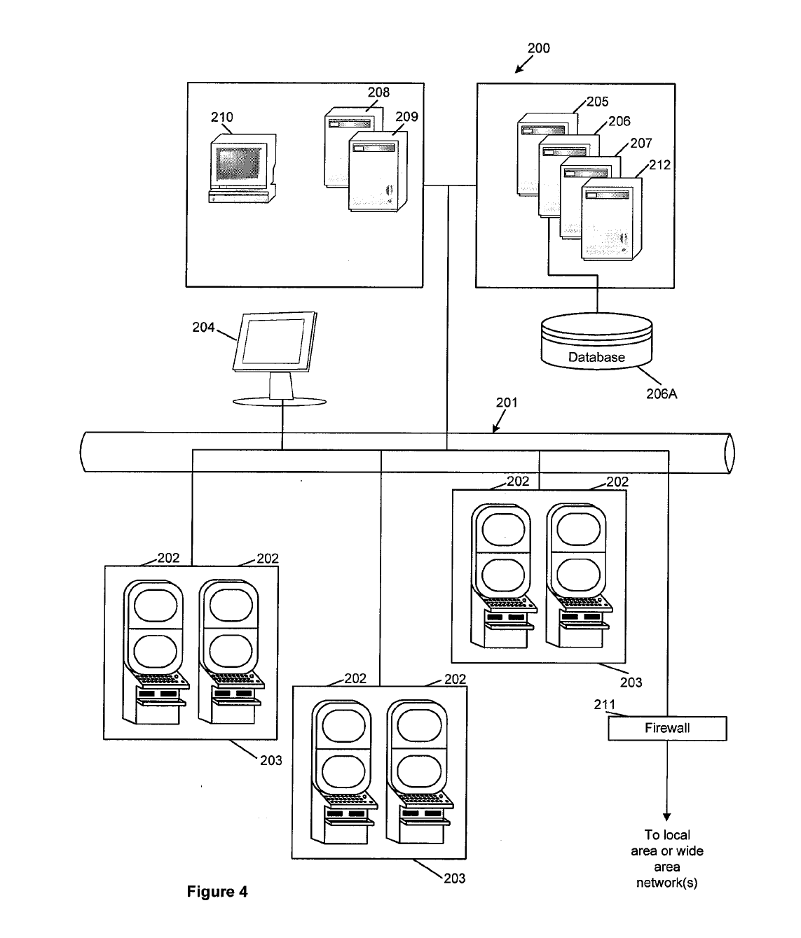

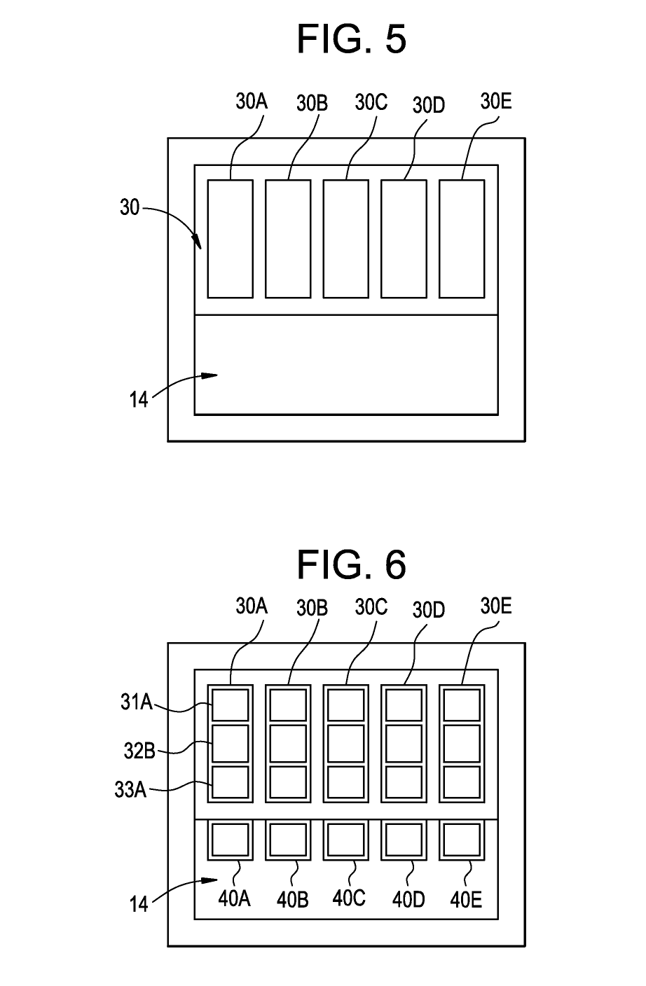

FIG. 4 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 4, are connected to the network 201. The gaming machines 202 provide a player operable interface and may be the same as the gaming machine 10 shown in FIGS. 1 to 3, or may have simplified functionality depending on the rules, guides, requirements, and/or preferences for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games based on the terminals.

### Further Detail of the Gaming Machine

As described above, and shown in further detail in FIG. 5, the gaming machine has five mechanical reels 30, and a video display 14 disposed adjacent and below the mechanical reels 30. Persons skilled in the art will appreciate that in other embodiments, the video display could be disposed above the reels or video displays could be disposed both above and below the reels. It will be appreciated that each of the mechanical reels has a plurality of symbol display positions arranged around the periphery at which symbols are disposed. In most implementations, there will be a single symbol at each symbol display position but as is known in the art, it is possible for there to be more than one symbol at a symbol display position depending on the design of the game being played on the gaming machine.

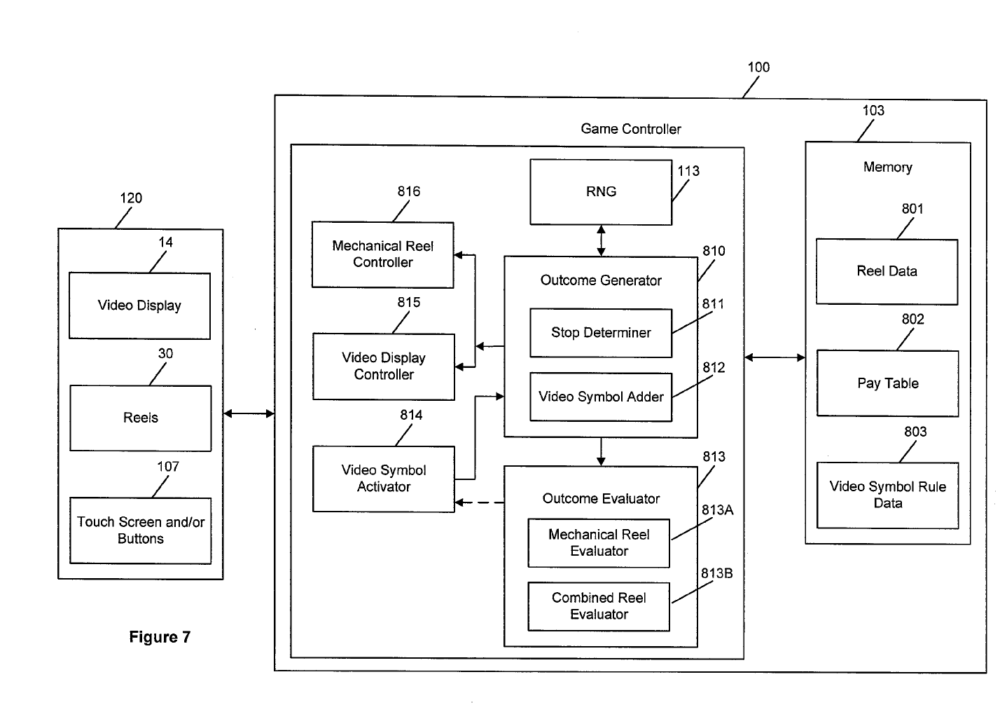

As will be appreciated by persons skilled in the art, due to the curvature of the mechanical reels, a limited number of symbol display positions, typically three, are viewable by a player and in prior art implementations, these symbols are those which are eligible for use in evaluation of the outcome of the game (depending on the player's selections as part of the player's wager and/or the rules of the game). In some embodiments, the video display is used to add one or more symbols of those found on the mechanical reels to one or more of the reels at video symbol display positions. In some embodiments, the number and timing of added video symbols can depend on factors such as the player's wager, a trigger occurring in the game, the nature of the trigger etc. FIG. 6 shows one example, where each of the five mechanical reels has three viewable symbol display positions 31,32,33 when stopped and the video display 14 is used to display a single video symbol display position 40 for each of the reels, thereby adding one symbol to each reel.

In one embodiment, of a gaming machine, the player operates the buttons and/or touch screen 107 interface to specify a wager and hence the win entitlement which will be evaluated for this play of the game and initiates a play of the game. Persons skilled in the art will appreciate that there may be more than one game round in a play of a gaming machine such as is the case when a series of free spins is awarded. The outcome of a game round may be no win, a win (for example from a winning combination of symbols), a contribution towards a win accrued over a plurality of game rounds, a trigger condition occurring etc. A game round involves at least one of the reels being “spun”—e.g. new symbols of the reels are selected for display at the display positions and the reel is either spun to a stop.

Persons skilled in the art will appreciate that a player's win entitlement will vary from game to game dependent on player selections. In most spinning reel games, it is typical for the player's entitlement to be affected by the amount they wager and selections they make (i.e. the nature of the wager). For example, a player's win entitlement may be based on how many lines they play in each game—e.g. a minimum of one line up to the maximum number of lines allowed by the game (noting that not all permutations of win lines may be available for selection) and how much they wager per line. In the embodiment, each win line selectable by the player is formed by a combination of symbol display positions, one from each of the five mechanical reels, the symbol display positions being located relative to one another such that they form a line and the video display symbol positions are added together with one or more additional win lines when an add video symbol condition is met. In one example, the add video symbol condition is that the player has placed an ante bet and the video display symbols are added for each play of the game where the player places the ante bet. In another example, the symbol display positions are used as part of a feature game such as a free game series, which may be triggered from the base game. In this example, symbols of the mechanical reels are used in the base game and the video symbols display positions are added during the feature game. In one variant of this example, the player must satisfy an eligibility criteria to be eligible for the added video display symbol positions such as having wagered the maximum number of lines or placed the maximum wager on the base game. Other eligibility criteria may be applied, for example that the player has played sufficient games, or the player is a member of a loyalty program.

In many games, the player's win entitlement is not strictly limited to the lines they have selected, for example, “scatter” pays are awarded independently of a player's selection of pay lines and are an inherent part of the win entitlement.

Once the player places their wager, the game controller carries out a play of the game. In FIG. 6, the processor 102 of game controller 100 is shown implementing a number of modules based on program code and data stored in memory 103. Persons skilled in the art will appreciate that various of the modules could be implemented in some other way, for example by a dedicated circuit.

These modules include the outcome generator 810 which operates in response to the player's placement of a wager and initiates a play of the game and generates a game outcome which will then be evaluated by award evaluator 813. The first part of forming the game outcome is for a stop determiner 811 to select a subset of symbols of the mechanical reels by selecting stopping positions for each of the reels (the stop position being the centre of the three rows of symbol display positions).

It will be appreciated that the symbols arranged around the reel specify a sequence of symbols for each reel such that the stop determiner 811 selects a subset of the symbols of each reel to be stopped in the viewable symbol display positions of each mechanical reel by selecting a stopping position in the sequence for each reel. In the embodiment, the stop positions are determined at random by the stop determiner selecting stopping positions for each reel using numbers obtained from RNG 113. In an alternative embodiment, a probability table stored in memory 64 is used to vary the odds of a particular stop position being selected.

In the embodiment, the video symbol rule data 803 specifies that the player must have placed video reel activator determines whether the player's wager includes an ante bet. If there is no ante bet, the above process concludes the generation of a game outcome and the mechanical reels are controlled by mechanical reel controller 816 to stop at the selected stop positions. The mechanical reel evaluator 813A of outcome evaluator 813 evaluates the generated outcome with reference to the win lines specified by the player, the symbols which are on those win lines, and the pay table 802 stored in memory 103.

When there is an ante bet, the video symbol activator 814 determines that a row of video symbols are to be added and activates video symbol adder 813. In the embodiment, the video reel adder 813 determines from the selected stop positions of each reel and reel data which specifies the symbol sequence of each reel, which symbol of each reel is next to symbol position 33 in the sequence and causes the video display controller 815 to display a video symbol on video display 14 at the video symbol display position 40 below the bottom mechanical reel symbol at position 33. For example, if part of the sequence of symbols on one if the reels is . . . J,K,Q,10,A,A . . . and the mechanical reel, displays Q,10,A, in positions 31,32 and 33 respectively the video symbol adder causes the display 14 to display a further A symbol at position 40 for the respective reel.

The outcome generator 810 passes data to the outcome evaluator 813 which specifies the selected symbols displayed on the mechanical reels 30 and the video display 14. The combined reel evaluator 814A determines whether any awards are payable based on the win lines which apply when the video symbols are added, the selected symbols and the pay table 802. Persons skilled in the art will appreciate that the pay table may be modified or different when the video symbol positions are populated. Any awards are displayed to the player and meters 104 are updated. In an advantageous embodiment, at least one added win line passes through at least one mechanical reel symbol and at least one video symbol.

In an alternative embodiment, the outcome evaluator 813 determines that a trigger condition is met by the symbols of the base game and advises the video symbol activator 814 to cause the video symbol adder 812 to operate. In one example, if a trigger condition is met, the video symbols are added to the current play of the base game and the symbols are re-evaluated. In another example, the trigger condition triggers a feature game having a number of free games and video symbols are added for each of the free games.

Persons skilled in the art will appreciate that other techniques may be used to trigger adding of the video symbol, for example, the video symbol activator 814 may conduct a random determination each time the game is played to determine whether to add the video symbols.

In another embodiment, the player obtains a win entitlement by selecting a number of reels to play and an amount to wager per reel in the same manner as in games which are marketed under the trade name “Reel Power” by Aristocrat Leisure Industries Pty Ltd. In the embodiment, the selection of the reel means that each displayed symbol of the reel can be substituted for a symbol at one or more designated display positions. In other words, all symbols displayed at symbol display positions corresponding to a selected reel can be used to form symbol combinations with symbols displayed at a designated, symbol display positions of the other reels. For example, if there are five reels and three symbol display positions for each reel such that the symbol display positions include three rows of five symbol display positions, the symbols displayed in the centre row are used for non-selected reels. As a result, the total number of ways to win is determined by multiplying the number of active display positions of each reel, the active display positions being all display positions of each selected reel and the designated display position of the non-selected reels. As a result for five reels and fifteen display positions there are 243 ways to win.

Such embodiments are suited to implementations where there are a plurality of different video symbol conditions and different numbers of video symbol positions are activated depending on which video symbol condition is met. For example, where there are five mechanical reels, there may be five different levels of ante bet and one to five video symbol positions 40 are added depending on the level that is bet. A further condition of such an embodiment may be that the player is also playing all reels. In such an example, if the player places the third level of ante bet, symbols are displayed at symbol positions 40A,40B,40C such that the player has 4*4*4*3*3=576 ways to win. In another example, the player may be entitled to place an ant bet irrespective of whether they are playing all reels. In such an example, the player may play one reel and the ante bet for three reels giving 4*2*2*1*1=16 ways to win.

In an example where the video symbol condition is that a trigger condition has to occur to trigger a feature game having a series of free games, there may be different triggers which add different numbers of video symbols. For example, three scattered symbols may add one video symbol in each free game, four scattered symbols may add three video symbols in each free game, and five scattered symbols may add five video symbols in each free game.

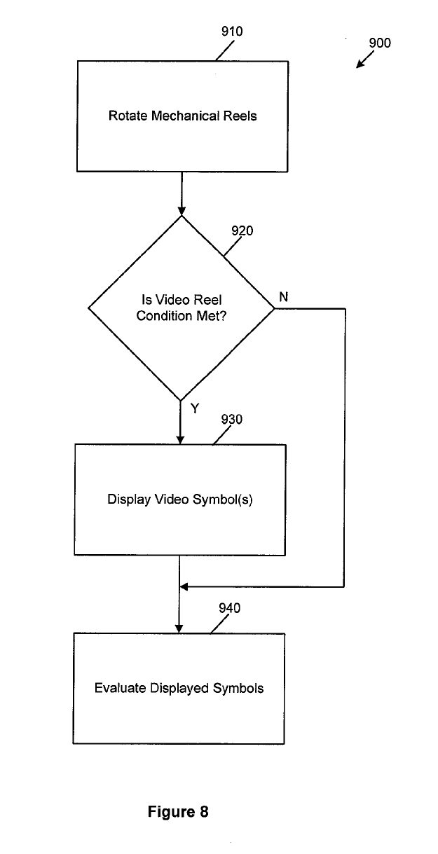

A method of an embodiment is summarised in relation to FIG. 8. The method 900 involves rotating the mechanical reels 910 and determining 920 whether a video reel condition is met. If a video reel condition is met, the method involves displaying 930 a video symbol or symbols in addition to the stopped symbols on the mechanical reels. The method concludes by evaluating the displayed symbols 940 irrespective of whether the only symbols are on the mechanical reels or also include the symbols on the video reels.

Further aspects of the method will be apparent from the above description of the system. It will be appreciated that at least part of the method will be implemented digitally by a processor. Persons skilled in the art will also appreciate that the method could be embodied in program code. The program code could be supplied in a number of ways, for example on a tangible computer readable storage medium, such as a disc or a memory (for example, that could replace part of memory 103) or as a data signal (for example, by transmitting it from a server). Persons skilled in the art, will appreciate that program code provides a series of instructions executable by the processor.

It will be understood to persons skilled in the art of the invention that many modifications may be made without departing from the spirit and scope of the invention, in particular it will be apparent that certain features of embodiments of the invention can be employed to form further embodiments.

For example persons skilled in the art will appreciate that there are a number of further variations may be achieved. In one such variation the symbols which are added as video symbols could be selected at random using a random number generated 113 by the video symbol adder 812 from the symbols 801 of the mechanical reels.

Further, rather than examples described above where at most a single video symbol is added for each mechanical reel, two or more symbols can be added per reel and/or different numbers of symbols can be added for each reel. An embodiment where two symbols are added for each reel is suited in particular to embodiments where there are displays above and below the mechanical reels.

It will be appreciated that in other embodiments, a first number of video symbols could be added in response to a first trigger occurring and the second number could be added in response to the second trigger condition being met.

Persons skilled in the art will appreciate that the same technique can be used with three mechanical reels or other numbers of reels.

Persons skilled in the art will appreciate that an advantage of the invention is that it increases the potential for interesting game complexity in mechanical reel based games without drastically altering the appearance of the game and as such the manner in which the games behave will be such that players who prefer mechanical reel based games will not be put off by the video aspects of the game.

It is particularly advantageous to, in effect, extend the reels as this does not affect the trust that the player has for a mechanical machine because they can physically see that the correct symbol(s) have been added by the video symbols. For example, as the reel slows, the player will see which symbol passed position 33 immediately before stopping and therefore will trust its presence at position 40.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium or computer-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming machine comprising:
a cabinet;
a game controller;
a plurality of mechanical reels mounted beside one another for rotatable movement relative to the cabinet, each mechanical reel carrying a plurality of symbols at a plurality of symbol display positions arranged around the outer periphery of the mechanical reel, the plurality of mechanical reels arranged relative to the cabinet such that a selected subset of the symbol display positions of each mechanical reel are viewable by a player when the reels are stopped, the symbols of the subsets being for use in the evaluation of an outcome of the game; and
at least one video display disposed adjacent the mechanical reels,
the game controller arranged to control the at least one video display to add to the symbols for use in the evaluation of the outcome of the game by displaying at least one additional symbol of the symbols of at least one reel as a video symbol at a video symbol display position adjacent one of the viewable symbol display positions of the respective mechanical reel.

2. A gaming machine as claimed in claim 1, wherein the symbols of the subsets are arranged in a plurality of rows and the game controller is arranged to add at least one video symbol for each reel to thereby add an additional row of symbols for use in the evaluation of the outcome of the game.

3. A gaming machine as claimed in claim 2, arranged to add a plurality of additional rows of symbols.

4. A gaming machine as claimed in claim 1, wherein the at least one video display is above the mechanical reels.

5. A gaming machine as claimed in claim 1, wherein the at least one video display is below the mechanical reels.

6. A gaming machine as claimed in claim 1, wherein the game controller is arranged to add each symbol such that an order of the symbols of each mechanical reel is preserved by each added video symbol.

7. A gaming machine as claimed in claim 1, wherein the game controller is arranged to add each video symbol in response to a video symbol condition being met.

8. A gaming machine as claimed in claim 7, wherein the video symbol condition is placement of a designated wager.

9. A gaming machine as claimed in claim 7, wherein the video symbol condition is occurrence of a designated game event.

10. A gaming machine as claimed in claim 1, wherein the game controller is arranged to determine whether to make an award to the player based on the symbols of the sets, each video symbol and a wager placed by a player of the gaming machine.

11. A gaming machine as claimed in claim 1, wherein the game controller is arranged to determine stopping positions of each of the mechanical reels.

12. A method of gaming comprising:
rotating a plurality of mechanical reels mounted to a cabinet to a stopping position, each mechanical reel carrying a plurality of symbols at a plurality of symbol display positions arranged around the outer periphery of the mechanical reel, such that a selected subset of the symbol display positions of each mechanical reel are viewable by a player when the reels are stopped;
controlling at least one video display adjacent to the mechanical reels to display at least one additional symbol of the symbols of at least one reel as a video symbol at a video symbol display position adjacent one of the viewable symbol display positions of the respective mechanical reel; and
evaluating the symbols of the subsets and the at least one video symbol to determine whether to make an award.

13. A method as claimed in claim 12, wherein the symbols of the subsets are arranged in a plurality of rows and the method comprises adding at least one video symbol for each reel to thereby add an additional row of symbols for use in the evaluation of the outcome of the game.

14. A method as claimed in claim 13, comprising adding a plurality of additional rows of symbols.

15. A method as claimed in claim 12, comprising adding each symbol such that an order of the symbols of each mechanical reel is preserved by each added video symbol.

16. A method as claimed in claim 12, comprising adding each video symbol in response to a video symbol condition being met.

17. A method as claimed in claim 16, wherein the video symbol condition is placement of a designated wager.

18. A method as claimed in claim 16, wherein the video symbol condition is occurrence of a designated game event.

19. A method as claimed in claim 12, comprising determining whether to make an award to the player based on the symbols of the sets, each video symbol and a wager placed by a player of the gaming machine.

20. A tangible computer readable medium comprising computer program code which when executed implements a method of gaming, the method comprising:
rotating a plurality of mechanical reels mounted to a cabinet to a stopping position, each mechanical reel carrying a plurality of symbols at a plurality of symbol display positions arranged around the outer periphery of the mechanical reel, such that a selected subset of the symbol display positions of each mechanical reel are viewable by a player when the reels are stopped;
controlling at least one video display adjacent to the mechanical reels to display at least one additional symbol of the symbols of at least one reel as a video symbol at a video symbol display position adjacent one of the viewable symbol display positions of the respective mechanical reel; and
evaluating the symbols of the subsets and the at least one video symbol to determine whether to make an award.
